(19) United States
(12) Patent Application Publication
(10) Pub. No.: US 2019/0313844 A1
(43) Pub. Date: Oct. 17, 2019

(54) Artificial Intelligence Driven Cooking System and Methods Employed Thereof

(71) Applicant: Futuristic Labs Private Limited, Hyderabad (IN)

(72) Inventors: GouthamGandhi Nadendla, Visakhapatnam (IN); Saloni Bedi, Kota (IN); Abhishek Yenji, Mumbai (IN); Mainak Mitra, North 24 Parganas (IN); RaviTeja Bhogavalli, Jangareddygudem (IN)

(21) Appl. No.: 16/382,350

(22) Filed: Apr. 12, 2019

(30) Foreign Application Priority Data
Apr. 13, 2018 (IN) 2018 41014237
Apr. 12, 2019 (IN) 201841014237

(51) Int. Cl. A47J 36/32; G06N 20/00; A47J 27/04; A47J 37/10

(52) U.S. Cl. CPC A47J 36/32; G06N 20/00; A47J 2027/043; A47J 37/108; A47J 27/04

(57) ABSTRACT

Exemplary embodiments of the present disclosure are directed towards an automated cooking system comprising of: a an intelligence layer is connected to databases, the databases configured to store various information and the intelligence layer configured to collect and analyze the technical data obtained from modules, a device layer comprises an automated cooking device and a cooking assistance module, cooking assistance module and automated cooking device are configured to retrieve information from databases and a feedback received from cooking assistance module is used to update cooking process, and computing device comprises voice assistant and health monitoring device are connected to the automated cooking device over network, the automated cooking device comprises a curry vessel and an ingredient rack, rice vessel positioned on first induction cooktop and curry vessel positioned on second induction cooktop, first induction cooktop configured for cooking rice and the second induction cooktop configured for curry making.

### CROSS-REFERENCE TO RELATED APPLICATIONS

This patent application claims priority benefit of Indian Provisional Patent Application No: 201841014237, filed on 13 Apr. 2018, and Indian Non-Provisional Patent Application No: 201841014237, filed on 12 Apr. 2019. The entire contents of these patent applications are hereby incorporated by reference herein.

### TECHNICAL FIELD

The disclosed subject matter relates generally to automated cooking, and more particularly to an artificial intelligence driven cooking system and methods employed thereof.

### BACKGROUND

Rapid development through Internet of things and artificial intelligence applied on varied household appliances is a cusp between the quality and speed of life. The conventional systems or devices fail to provide the indigenous taste and hygiene as per the requirement of the user. Cooking as a technology involves step by step procedures with an amalgamation of right ingredients in the right quantity.

Existing cooking apparatus lack the capacity to sense and analyse the recipe intended to be cooked. Preliminary steps involving addition of ingredients and regular checks are to be performed by the user to ensure smooth cooking process to make the recipe palatable, thus questioning the skill of the user. Given the modern day lifestyle attention to fitness goals is equally important, thus making calorific and nutritional values decisive parameters while cooking. Paucity of time is another challenge faced by modern day man and is in need of a cooking system which can cook right and fast. Existing cooking apparatus cannot remotely monitor or start or stop the cooking process. Existing cooking apparatus also cannot measure feedback regarding the completion of the cooking process or the taste of the food.

In the light of aforementioned discussion, there exists a need for a system and method involving the use of automation technology in cooking by the use of artificial intelligence.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An exemplary objective of the present disclosure are directed towards an automated cooking system and method monitored in an artificial intelligence environment based on the cooking directions provided in the user interface.

Yet another exemplary objective of the present disclosure is directed towards implementation of simple, energy saving, and time saving technique.

Yet another exemplary objective of the present disclosure is directed towards customizing recipes in accordance with the taste buds or taste profile of the user.

Yet another exemplary objective of the present disclosure is directed towards recommendation of customized recipes based on health profile of the user.

Yet another exemplary objective of the present disclosure is directed towards measurable feedback regarding the doneness and the taste of the food.

Yet another exemplary objective of the present disclosure is directed towards remotely monitoring or initiating or stopping the cooking process.

Another exemplary objective of the present disclosure is directed towards connecting automated cooking devices over a network that learns from each other and improve efficiency.

Another objective of the present disclosure is directed towards automating the cooking operations (for example, weighing, dispensing, sautéing, steaming, simmering, boiling, frying, and stirring) and cooking any recipe which can be cooked using these cooking operations.

Another objective of the present disclosure is directed towards enabling experienced chefs to use semi-automatic assistant mode to control different sections of the appliance, or to cook complex recipes.

Another objective of the present disclosure is directed towards accurately dispensing the right amounts of spices and flavors depending upon the ingredients that are being used eliminating the guess work of how to make dish taste good.

Another objective of the present disclosure is directed towards controlling the temperature of the automated cooking device accurately and maintaining the temperature consistently over the period of time.

Another objective of the present disclosure is directed towards steaming the ingredients before sautéing thereby reducing the cooking time.

Another objective of the present disclosure is directed towards dispensing the specific weights of ingredients at specific intervals of time based on the recipe.

Another objective of the present disclosure is directed towards tracking the cooking process continuously to give real time feedback to the cooking assistance module.

Another objective of the present disclosure is directed towards collecting feedback from the users on various factors such as taste, doneness, thickness of the gravy on a scale ranging from 0-5 which is fed in the cooking assistance module to improve the cooking process of the recipes to fine tune the machine learning algorithm's parameters.

Another objective of the present disclosure is directed towards analyzing the user's food consumption and activity levels.

Another objective of the present disclosure is directed towards enabling the users to log and track their nutrient consumption over the period of time.

Another objective of the present disclosure is directed towards connecting the artificial intelligence driven cooking system to cloud database which contains constantly updated and curated set of recipes.

Another objective of the present disclosure is directed towards auto-updating from cloud servers.

Another objective of the present disclosure is directed towards connecting automated cooking device to the cooking assistance module installed in a computing device over a network.

Another objective of the present disclosure is directed towards constant firmware upgrades from servers and diagnostics dump.

Another objective of the present disclosure is directed towards solving mentally taxing aspects of the cooking cycle such as recipe planning or scheduling meals over a week or multiple weeks and auto generates shopping lists that you either purchase or order from one of supply partners.

Another objective of the present disclosure is directed towards scheduling recipes based on dietary restrictions or according to a specific diet like “low carb diet, or high protein diet” etc. and to maintain good nutrient profile over the week.

Another objective of the present disclosure is directed towards filtering recipes and generating pantry list or shopping list based on what is available in home by taking a picture of the ingredients (for example, vegetables) or by scanning a barcode.

Another objective of the present disclosure is directed towards using machine learning techniques to learn the preferences of the user and are able to modify any recipe to match the taste profile of the user.

Another objective of the present disclosure is directed towards reconfiguring recipes based on the dietary preferences of the user.

Another objective of the present disclosure is directed towards using machine learning techniques to identify the perfect cooking parameters for a particular recipe.

Another objective of the present disclosure is directed towards using machine learning techniques to identify flavors of a particular region. For example, learn how “Andhra Style” or “Kerala Style” recipes are made i.e. the spice and flavor combination and then use this to port recipes from one region to another to create novel recipes for example how we can port chicken curry from Andhra style to Kerala style to Rajasthan style etc.

Another objective of the present disclosure is directed towards using machine learning techniques to identity flavor combinations that go together and suggest additions to existing standard recipes to enhance their taste.

Another objective of the present disclosure is directed towards using machine learning techniques to identify basic cooking process templates.

An exemplary aspect of the present disclosure is directed towards a recipe machine learning module fed with learning algorithms to analyze the inputs of the data from multiple sources in conjunction to obtain an overview and idea about the doneness of food; a health data machine learning module configured to collect and analyze a health data obtained from the wearable health monitoring device which, a natural language processing module initiates communication with the user by recognizing the voice of the user for accepting commands and sensor reading and user feedback is feedback for fine tuning the inbuilt algorithms; a plurality of sensors to detect the adequacy of requisite parameters during cooking; and a device layer to retrieve the technical data for preparation of a recipe from the database by the user interface of the system and cooking assistance module.

Another exemplary aspect of the present disclosure is directed towards the artificial intelligence driven cooking system comprising an intelligence layer that is connected to a plurality of databases, the plurality of databases configured to store various information and the intelligence layer configured to collect and analyze the technical data obtained from a plurality of modules.

Another exemplary aspect of the present disclosure is directed towards the artificial intelligence driven cooking system comprising a device layer that comprises an automated cooking device and a cooking assistance module, the cooking assistance module and the automated cooking device are configured to retrieve information from the plurality of databases and the feedback received from the cooking assistance module is used to update the cooking process.

Another exemplary aspect of the present disclosure is directed towards the artificial intelligence driven cooking system comprising a computing device comprises a voice assistant and a wearable health monitoring devices which are third party devices that are connected to the cooking assistance module over a network and pull in data points to map them against the eating habits, a user's interaction with the automated cooking device is through a touch screen, and the voice recognition feature through the voice assistant and the wearable health monitoring device configured to provide the health data to the plurality of modules, the automated cooking device comprises a curry vessel and an ingredient rack, the ingredient rack is configured to hold ingredients that go into the curry vessel and the ingredient rack rotates based on a recipe to dispense the ingredients into the curry vessel at a predetermined interval of time, a rice vessel positioned on a first induction cooktop is configured for rice cooking and passive steaming and the curry vessel positioned on a second induction cooktop is configured for curry making.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is architecture for an artificial intelligence driven automated system, according to an exemplary embodiment of the present disclosure.

FIG. 2 is a flow diagram depicting an artificial intelligence driven cooking, according to an exemplary embodiment of the present disclosure.

FIG. 3A-3F are diagrams depicting various views of the artificial intelligence driven automated cooking device, according to an exemplary embodiment of the present disclosure.

FIG. 4 is a block diagram depicting the artificial intelligence driven cooking system, according to an exemplary embodiment of the present disclosure.

FIG. 5 is a diagram depicting an embodiment of automated cooking device (P408) as shown in FIG. 4, according to an exemplary embodiment of the present disclosure.

FIG. 6 is a flow chart depicting a method for initiating operations of the automated cooking device, according to an exemplary embodiment of the present disclosure.

FIG. 7 is a block diagram illustrating the details of processing system, in which various aspects of the present disclosure are operative by execution of appropriate software instructions.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

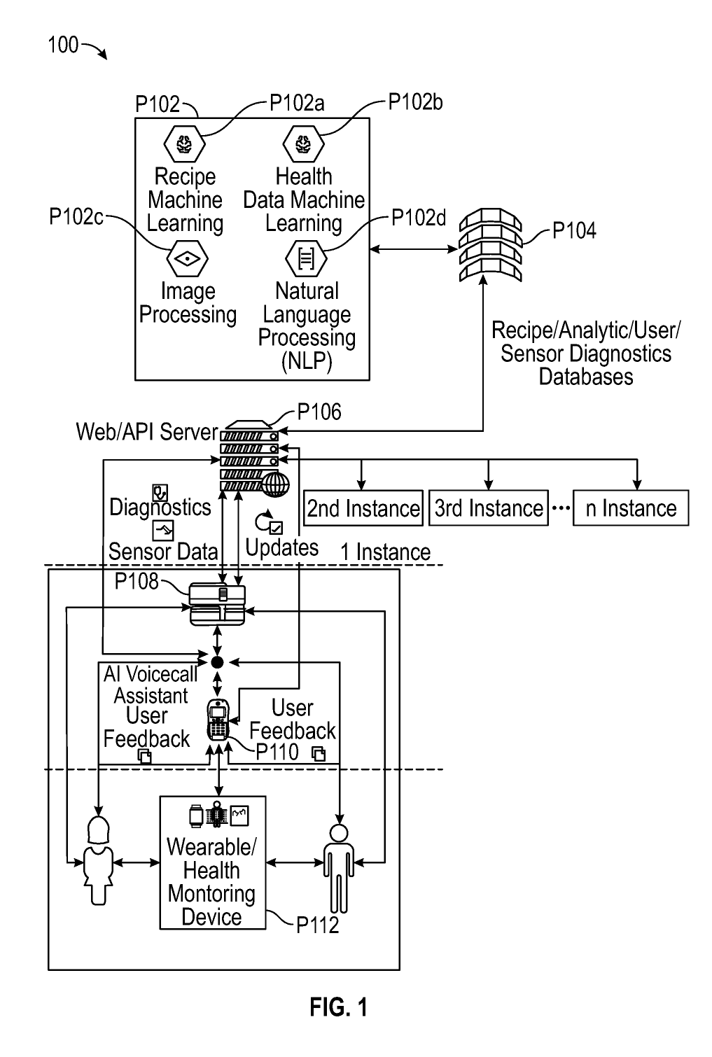

Referring to FIG. 1, FIG. 1 is a diagram 100 depicting architecture of an artificial intelligence driven cooking system, according to an exemplary embodiment of the present disclosure. The artificial intelligence driven cooking system 100 may be referred to as system for further reference. The architecture 100's first level is an intelligence layer (P102), and modules such as a recipe machine learning module (P102a), a health data machine learning module (P102b), an image processing module (P102c), and a natural language processing (NLP) module (P102d). The intelligence layer (P102) is configured to collect and analyze the technical data obtained from the modules such as the recipe machine learning module (P102a), the health data machine learning module (P102b), the image processing module (P102c), and the natural language processing (NLP) module (P102d). The data obtained from multiple sensors is fed into the algorithm to fine tune the machine learning module. These algorithms include but are not limited to, the name and number of ingredients with prescribed quantities, the sequence of adding the ingredients and special requirements like boiling, stirring, and the like. The health data machine learning module (P102b) collects and analyses the health data obtained from the wearable health monitoring device (P112) which is worn by the user as an accessory and the user could also manually add the health information in the accompanying cooking assistance module and/or system user interface. The image processing module (P102c) is configured to collaborate with the sensors to obtain doneness of food. The image processing module (P102c) comprises of an Infra-red (IR) thermal camera and a high definition (HD) camera. During the process of cooking, the IR thermal camera is configured to generate a heat map of the whole surface where the curry vessel is placed to obtain an image of the whole surface of the vessel. The HD camera works on the principle of obtaining an image of the food being cooked to check the doneness of food. For example: if the command fed through the sensor data is to “fry the onions till they turn brown” then, the HD camera would enable the image processing module to identify the doneness of the onions as per the command through various images generated. The NLP module (P102d) is configured to recognize the speech in the form of user's commands. For example; the user may command rice, or curry depending on the requirement and the NLP module (P102d) executes the command.

The second layer is the information layer which comprises of various databases (P104). The databases (P104) store various information, not limiting to, recipes (which are the system's central data repository) which provide information to the user as per the requirement, user's login information, user's taste profile information, cuisine type, number of persons to be served, information from various sensors like temperature, humidity based on the weight of the ingredients required for a recipe, improvisations suggested for every recipe, and the like. The technical data for preparation of a recipe is stored in the database (P104). The data processing takes place in the cooking assistance module as well as the web based servers. The recipes may be pre-installed which are configured to be edited and updated as per the requirement of the user. The database (P104) may be expanded depending on the number of recipes added. The recipes may be added by the user, or any person skilled in the art, not limiting to onboard chefs.

A device layer (P106) consists of the automated cooking device and a cooking assistance module. The information from the database (P104) is retrieved by the user interface of the system and the cooking assistance module. The feedback received from the cooking assistance module is used to update the cooking process and fine tuning of the inbuilt algorithms. This information is provided by streaming data by the cooking assistance module and an application programing interface. The sensor data processing involves various sensors, not limiting to, temperature sensors for real time accurate control of temperature of the cooking tops. Load cells (not shown in the figure) are configured to accurately weigh ingredients and spices. Humidity sensors sense the requisite humidity for cooking. An acoustic sensor is for sensing whether the food is done as per the requirement. A proximity sensor is for detecting the movement of an object and/or a person near the system. It further detects the placement of the pod, i.e. whether a pod is placed in the designated slot, the placement of rice vessels and the curry vessel at their designated slots, an unwanted opening of door, for example the spice rack door and/or the ingredient rack door, and the like. A pressure sensor is configured to detect the pressure maintained in the steamer section of the vegetable steamer which uses the steam to the steam ingredients in the ingredient section.

The user's interaction with the automated cooking device (P108) is through the touch screen; and/or voice recognition feature through a voice assistant (P110) which may use microphone; and/or through the cooking assistance module. The wearable health monitoring device (P112) can be connected to the cooking assistance module and the system pulls in the data points. Based on the data generated, an updated recipe and/or diet may be recommended. For example: a low salt recipe for a user with Blood Pressure, a low sugar and/or no sugar recipe for a user with diabetes, or a low fat diet for a user intending weight loss, and the like.

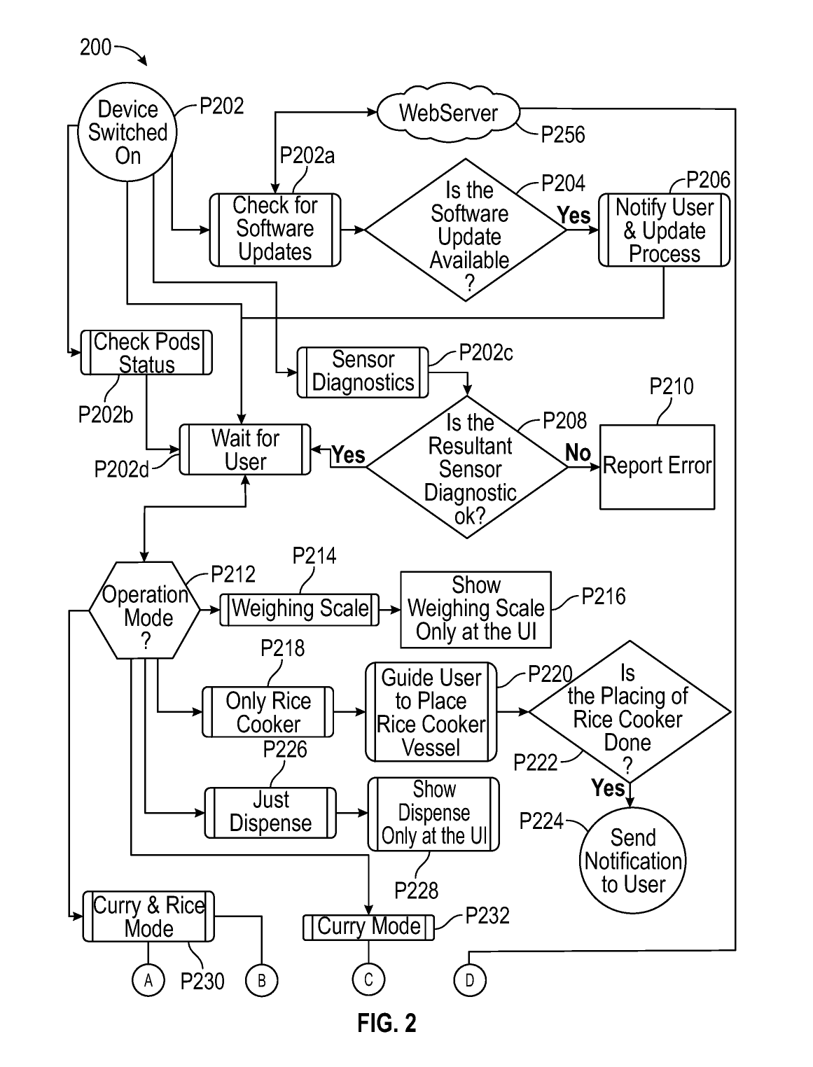

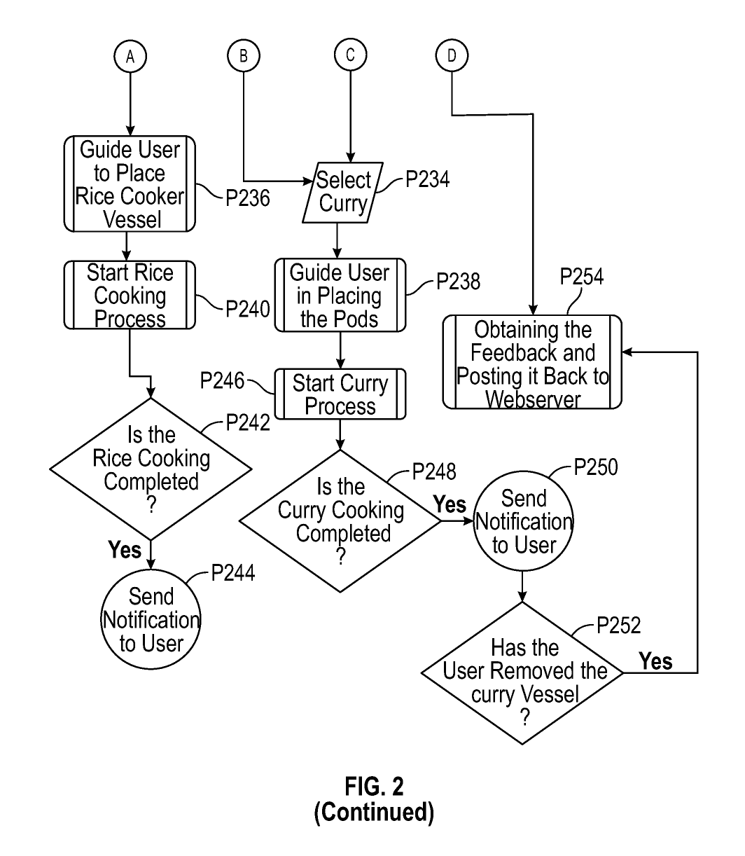

Referring to FIG. 2, FIG. 2 is a flow diagram 200 depicting an artificial intelligence driven cooking, according to an exemplary embodiment of the present disclosure. The user switches on the automated cooking device (P202) for the preparation of desired food. The food prepared may not be limited, to a rice preparation or curry preparation and/or both. Once the automated cooking device is switched on a series of checks are performed, not limiting to, checking for an update of the cooking assistance module (P202a), checking for the status of pods (P202b), where the pods may not be limited to, an oil pod, a water pod, ingredient pods, and the like. The sensor diagnostics is activated (P202c), and the automated cooking device waits for the user (P202d) for performing further operations. It enquires for the availability of any instruction regarding the update of the cooking assistance module (P204), which, when confirmed is notified to the user and the updating process starts (P206). The sensor diagnostics functioning is enquired (P208) and upon confirmation the process continues to step (P202d). An error is reported (P210) upon recognition of error in sensor diagnostics. The user decides on the various operation modes (P212) which are: the weighing scale mode (P214) when activated the user interface depicts an option of displaying only the weighing scale (P216). The weighing scale mode (P214) may act as a standalone mode. Alternatively, an only rice cooker mode (P218) guides the user to place rice cooker vessel (P220), which upon confirmation about placing the rice cooker vessel (P222) is notified to the user (P224). A just dispense mode (P226) may act as a standalone mode which the user interface depicts an option of dispense only (P228). This mode enables the dispensing of a standalone ingredient from the spice rack. Another operation mode viz. curries and rice mode (P230) when opted, guides the user to place the rice cooker vessel on the induction cooktop (P236). If the user prefers to go for a curry mode (P232), then a select curry option (P234) is activated. The select curry option (P234) may also be a continuation step to curries and rice mode (P230). Upon placing the rice cooker vessel the rice cooking process starts (P240). An enquiry (P242) to confirm the completion of rice cooking process is done which results in sending notification to the user (P244). As a continuation to select curry option (P234), the user is guided in placing the vessels on the induction cooktop (P238). The induction cooktop 1 (P236) and induction cooktop 2 (P238) can be used on a standalone mode. The curry preparation process starts (P246) which is enquired for completion (P248). Upon confirmation, the user is notified by sending notification (P250), it is enquired whether the user has removed the vessel in which the curry was cooked (P252), which upon confirmation is prompted for a feedback after sometime and posted (P254) back to the webserver (P256) which is configured to process the requests and feedback obtained from the users that is utilized to recommend customized recipe as per the requirement of the user.

The recipe machine learning module (P102a of FIG. 1) utilizes inputs of the data from multiple sources in conjunction to obtain an overview and idea about the doneness of food. The conjunction involves the images obtained from IR thermal camera, the HD camera, the sensors for sensing humidity and temperatures. Additionally, the sensors can sense the doneness of food through acoustics. For example: The crackling of nuts, splatter of food, popping of seeds, and the like. The learning algorithm is configured to update itself from the updates generated based on the inputs by the user. For example: the updates may be based on the current taste profile of the user which may be updated in the settings. Like the user's taste may be spicy food, less oily, and the like. The learning algorithm updates itself and finds patterns to guess the doneness of food matching the user's taste. The propagated results enable the automated cooking device (P108) to learn and perform in a smart way each time food is intended to be cooked.

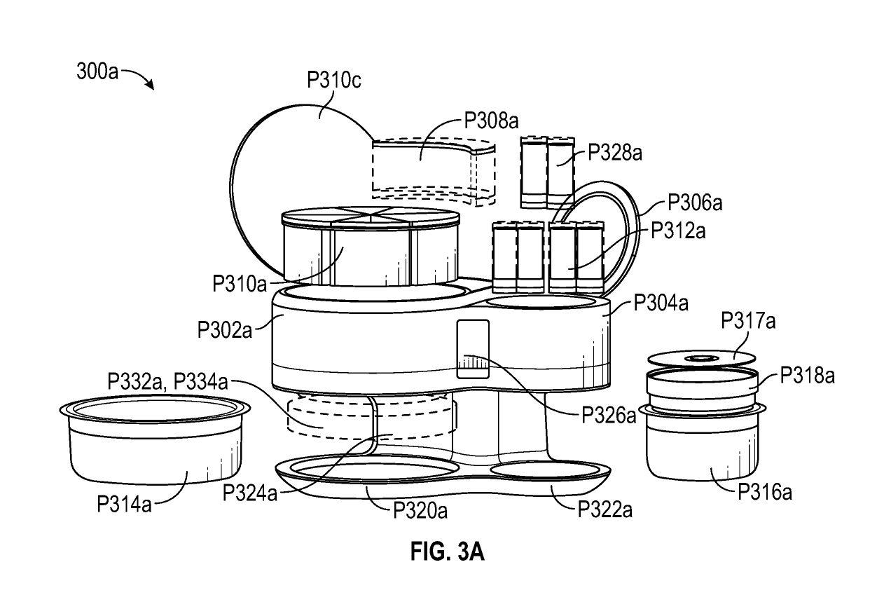

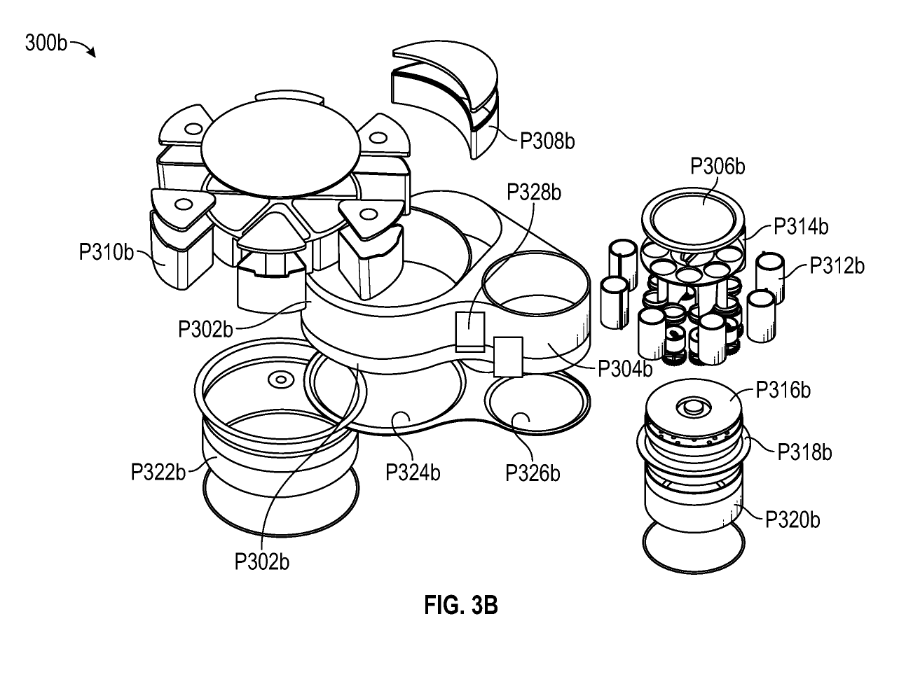

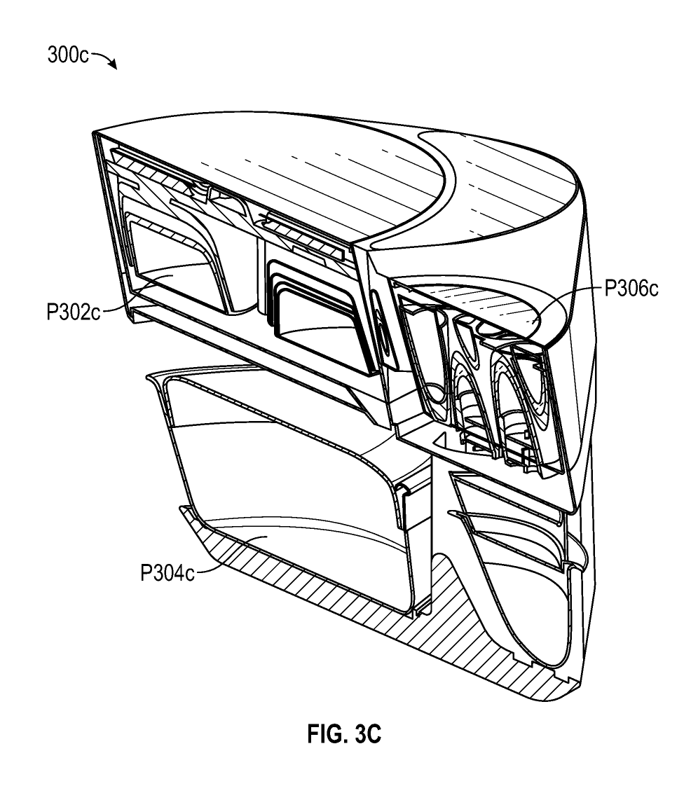

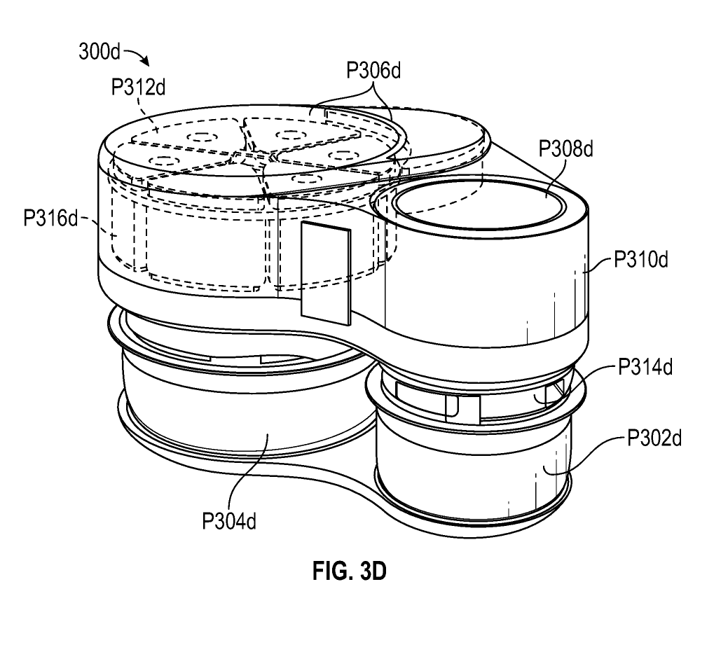

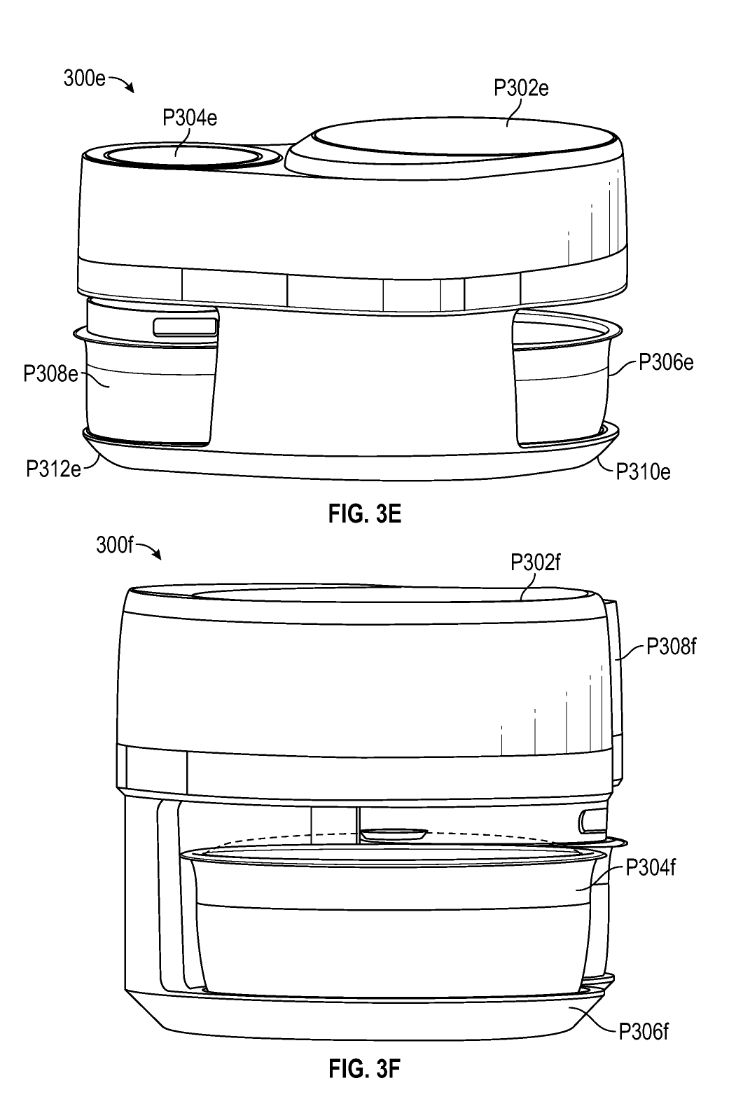

Referring to FIG. 3A-3F, FIG. 3A-3F are diagrams 300a-300f depicting various views of the automated cooking device (P108), according to an exemplary embodiment of the present disclosure. FIG. 300a is a three dimensional view of the automated cooking device. Ingredients rack (P302a) is not limited to, six ingredient pods (P310a). Ingredients other than oils essential for cooking and spices are added to each of these ingredient pods (P310a) and its lid P310c. A spice rack (P304) consists of not limiting to, eight spice pods (P312a) for storing at least eight types of spices, and not limiting to, two oil pods (P328a) for storing oils to be used for cooking. Two different varieties of oils can be accommodated in both the oil pods (P328a) in a given time. The ingredients are weighed in a weighing scale (P306a). The weight of the ingredients depends on the requirements based on the recipe intended to be cooked. A water pod (P308a) is juxtaposed to the ingredients pods (P310a). The water pod (P308a) holds water as added by the user based on the requirement of the user. A curry vessel (P314a) or a rice vessel (P316a) is placed on top of induction cooktop 1 (P320a) or induction cooktop 2(P322a) based on the requirement of the user. The temperature of the induction cooktops may be controlled through temperature sensors based on the requirement of the recipe. A stirrer (P324a) is positioned above one of the induction cooktop 1 (P320a) or induction cooktop 2 (P322a), aids in blending various flavors and prevents sticking of the ingredients in the vessels by going around them. A vegetable steamer (P318a) is configured to be placed into a rice vessel (P316a). The vegetable steamer (P318a) is covered by a lid (P317a). The vegetable steamer (P318a) is a passive steamer where the vegetables required to be steam cooked are placed in the steamer (P318a) which is in turn placed inside the rice vessel (P316a) on induction cooktop 2 (P322a). The vapors generated are returned to the rice vessel (P316a) or left to the atmosphere. A touch screen (P326a) is the user interface. Various modes for operating the automated cooking device are displayed on the touch screen (P326a) for the user to operate as per the requirement. Two cameras, not limiting to, the IR thermal camera (P332a) and the HD camera (P334a) are located inside the cylindrical section positioned at the center of the stirrer (P324a). An ingredient steamer (350b), not shown herein is an active steamer which is positioned at the back of the curry vessel (P314a) and functions by steaming the ingredients from the ingredients rack (P302a) prior to pushing them into curry vessel (P314a). An example of the same may be steaming of lentils, tubers and the like.

FIG. 3B is a representation 300b, of an exploded view of the automated cooking device, according to an exemplary embodiment of the present disclosure. The FIG. 300b depicts the order and assembly of various sub-parts of the automated cooking device. The ingredients rack is represented as (P302b), the spice rack is represented as (P304b), a lid (P306b) is for closing the racks and the spice pods (P312b) and the oil pods (P314b). The water pod is represented as (P308b) and the ingredient pods as (P310b). A lid (P316b) is for covering the vegetable steamer (P318b) which may be placed inside the rice vessel (P320b). The curry vessel is represented as (P322b). The induction cooktops are represented as (P324b) and (P326b), and the user interface which is the touch screen is represented as (P328b).

FIG. 3C is a cross sectional view 300c, of the automated cooking device, which depicts the lengthwise and breadthwise view of various parts of the automated cooking device, according to an exemplary embodiment of the present disclosure. The ingredient pods are represented as (P302c). The induction cooktop is represented as (P304c) on which the rice vessel and/or vessel rests for cooking. The lid (P306c) is for covering the spice pods and/or oil pods placed in the spice rack.

FIG. 3D is the top view 300d, of the automated cooking device, according to an exemplary embodiment of the present disclosure. The view depicts a top cover for the automated cooking device. The rice vessel is represented as (P302d) and the curry vessel as (P304d). The lid (P306d) is placed on top of the ingredient pods (P312d) which are housed inside the ingredients rack (P316d). The lid (P308d) is for covering the spice rack (P310d). A vegetable steamer is represented as (P314d).

FIG. 3E depicts the back side view 300e, of the automated cooking device, according to an exemplary embodiment of the present disclosure. The lid on ingredients rack is represented as (P302e) and the lid on spice rack is represented as (P304e). The rice vessel is represented as (P308e) and the curry vessel is represented as (P306e). The induction cooktop placed below the rice vessel (P308e) is represented as (P312e) and the induction cooktop placed below the curry vessel (P306e) is represented as P310e.

Referring to FIG. 3F depicts the left sided view 300f, of the automated cooking device, according to an exemplary embodiment of the present disclosure. The lid (P302f) is for covering the spice rack (P308f). The rice vessel (P304f) is placed on the induction cooktop (P306f).

The mechanism involved in the functioning of the parts in the FIG. 300b-300f) is similar to the description in FIG. 300a.

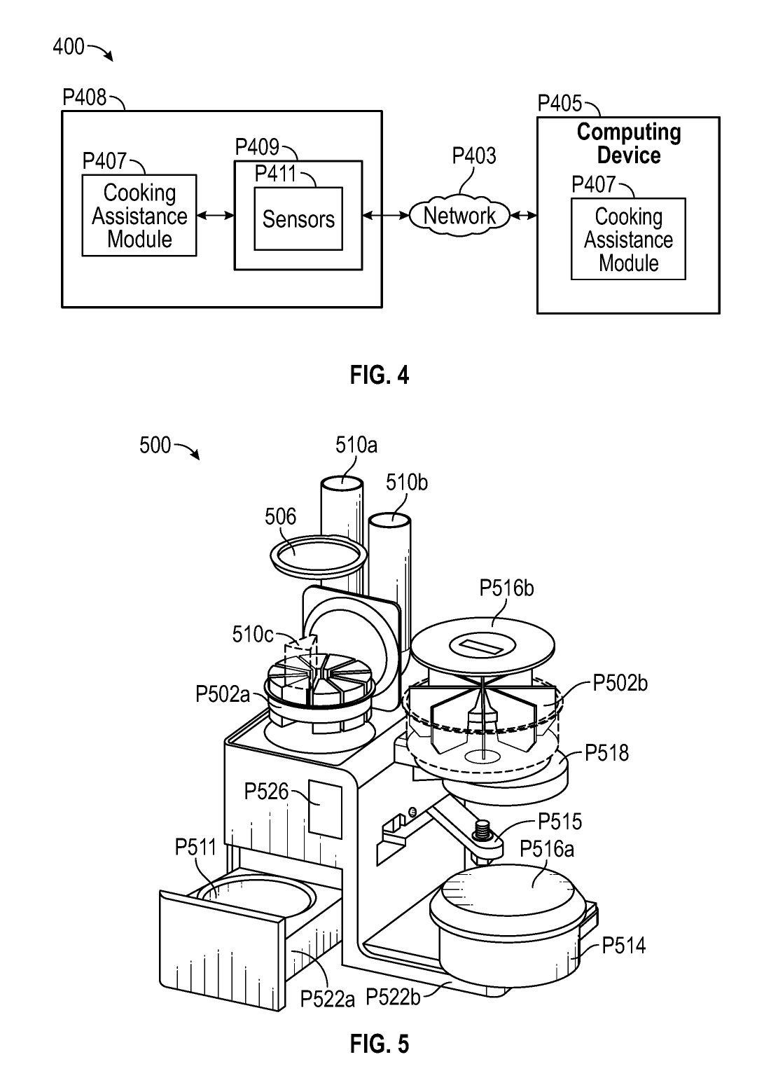

Referring to FIG. 4, FIG. 4 is a block diagram 400 depicting the artificial intelligence driven cooking system, according to an exemplary embodiment of the present disclosure. The artificial intelligence driven cooking system 400 comprises an automated cooking device (P408), a network (P403), and a computing device (P405). The automated cooking device (P408) is connected to the computing device (P405) over the network (P403). The network (P403) may include but is not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The computing device (P405) comprises a cooking assistance module (P407).

The automated cooking device (P408) comprises the cooking assistance module (P407), and a processing device (P409). The processing device (P409) comprises sensors (P411). The processing device (P409) may include but not limited to, a microcontroller (for example ARM 7 or ARM 11), a raspberry pi3 or a Pine 64 or any other 64 bit processor which can run Linux OS, a microprocessor, a digital signal processor, a microcomputer, a field programmable gate array, a programmable logic device, a state machine or logic circuitry, Arduino board. The sensors (P411) comprise temperature sensors, humidity sensors, an acoustic sensor, a pressure sensor, a proximity sensor, and so forth. The temperature sensors are configured for real time accurate control of temperature of the induction cooktops. The humidity sensors are configured to maintain required humidity. The acoustic sensor is configured to sense spices crackle. The pressure sensor is configured to detect the pressure maintained in the steamer which steams the ingredients. The proximity sensor is configured for detecting the movement of an object and/or a person near the automated cooking device (P408). The proximity sensor further detects the placement of the pod, i.e. whether a pod is placed in the designated slot, the placement of rice vessels and the curry vessel at their designated slots, an unwanted opening of door, for example the spice rack door and/or the ingredient rack door, and the like. A pressure sensor is configured to detect the pressure maintained in the steamer section of the vegetable steamer which uses the steam to the steam ingredients in the ingredient section.

Although the computing device (P405) is shown in FIG. 4, an embodiment of the environment may support any number of computing devices. The computing device (P405) may include, but are not limited to, a desktop computer, a personal mobile computing device such as a tablet computer, a laptop computer, or a netbook computer, a smartphone, a video game device, a digital media player, a piece of home entertainment equipment, backend servers hosting database and other software, and the like. Each computing device supported by the environment is realized as a computer-implemented or computer-based device having the hardware or firmware, software, and/or processing logic needed to carry out the intelligent messaging techniques and computer-implemented methodologies described in more detail herein. The computing device (P405) may be configured to display features by the cooking assistance module (P407).

The computing device (P405) may include a cooking assistance module (P407), which is accessed as a mobile application, web application, software that offers the functionality of accessing mobile applications, and viewing/processing of interactive pages, for example, are implemented in the computing device (P405) as will be apparent to one skilled in the relevant arts by reading the disclosure provided herein. The cooking assistance module (P407) may be downloaded from the cloud server (not shown). For example, the cooking assistance module (P407) may be any suitable application downloaded from GOOGLE PLAY® (for Google Android devices), Apple Inc.'s APP STORE® (for Apple devices), or any other suitable database. In some embodiments, the cooking assistance module (P407) may be software, firmware, or hardware that is integrated into the computing device (P405). The cooking assistance module (P407) may be an artificial intelligence powered, needs-based, social networking service to enable real-time conversations (for example, voice conversations) between the users and automated cooking device (P408). Users request the cooking assistance module (P407) for a connection from the computing device (P405) based upon their interests or a need they have at any given time.

The cooking assistance module (P407) is configured allow the users to add or edit or modify or customize recipes. The users schedule or plan recipes based on filters. The cooking assistance module (P407) is also configured to generate shopping lists based on the schedule. The cooking assistance module (P407) is also configured to enable the user to track food and also provide a live view panel to see the status of the cooking process. The cooking assistance module (P407) is also comprises a control panel which acts as a remote control to the automated cooking device (P408). The user selects a recipe either on the automated cooking device (P408) screen or the cooking assistance module (P407).

Referring to FIG. 5, FIG. 5 is a diagram 500 depicting an embodiment of automated cooking device (P408) as shown in FIG. 4, according to an exemplary embodiment of the present disclosure. FIG. 500 is a three dimensional view of the automated cooking device. The automated cooking device (P408) comprises pods (P510a, P510b, P510c), a weighting scale (P506), a first rack (P502a), a second rack (P502b), a touch screen (P526), a rice vessel (P511), a first induction cooktop (P522a), a second induction cooktop (P522b), a steamer (P518), a mechanical arm (P515), a vessel Lid (P516a), a rack lid (P516b), and a curry vessel (P514).

The pod (P510a) for storing oils to be used for cooking. Two different varieties of oils can be accommodated in the oil pods in a given time. The ingredients are weighted in the weighing scale (P506). The weight of the ingredients depends on the requirements based on the recipe intended to be cooked. The water pod (P510b) is juxtaposed to the ingredients pod (P510c). The water pod (P510b) holds water as added by the user based on the requirements of the user. Ingredients other than oils essential for cooking and spices are added to each of these ingredient pods (P510c). Various modes for operating the automated cooking device (P408) are displayed on the touch screen (P526) for the user to operate as per the requirement. A rice vessel (P511) or a curry vessel (P514) (for example, curry vessel) is placed on top of first induction cooktop (P522a) or second induction cooktop (522b) based on the requirement of the user. The temperature of the induction cooktops (P522a or P522b) may be controlled through temperature sensors based on the requirement of the recipe. The steamer (P518) is configured to be placed into the curry vessel (P514). The passive steaming may happen inside the rice vessel (P511). The active steamer (P518) is in the bottom section of the second rack (P502b) and may steam vegetables that go into the curry inside the curry vessel (P514) on the second induction cooktop (P522b). The vessel lid (P516a) has a section of it which can be opened or closed to simulated open and closed lid cooking additions. The vessel lid (P516a) is configured for covering the curry vessel (P514). The vapours generated are returned to the curry vessel (P514) on the second induction cooktop (P522b). Various modes for operating the automated cooking device (P408) are displayed on the touch screen (P508) for the user to operate as per the requirement. The mechanical arm (P515) which acts a base to the second rack (P502b), holds the mechanism to rotate the second rack (P502b) and also rotate the stirrer. The mechanical arm (P515) is foldable into the main frame so the user can use the induction cooktop (P522a or P522b) in a standalone mode. The rack lid (P516b) is configured to cover the second rack (P502b).

The automated cooking device (P408) is configured to show what ingredients are needed and checks if the ingredients available in the pantry-which lets the user to either use them or get them from the store. The automated cooking device (P408) runs a status cycle to check the levels of liquids and condiments. The automated cooking device (P408) is also configured to check if all the required condiments for the particular recipe are present in the first rack (P502a). The first rack (P502a) may be represented as the condiments rack. If not present or levels are low the interface guides the user to either replace or refill the pods (P510a, P510b, P510c). The user is guided in the interface to weigh and place the perishable ingredients in to the second rack (P502b) sequentially. The second rack (P502b) may be represented as the ingredient rack. Once all the ingredients are loaded the automated cooking device (P408) starts the operations based on whether it is in fully automatic or semi-automatic mode. In fully automatic mode, the automated cooking device (P408) executes the recipe step by step by controlling the induction cooktop (P522) temperature continuously using the feedback from the sensors. The sensors may include, but are not limited, an image sensor, thermal sensor (top and bottom), humidity sensor, and so forth.

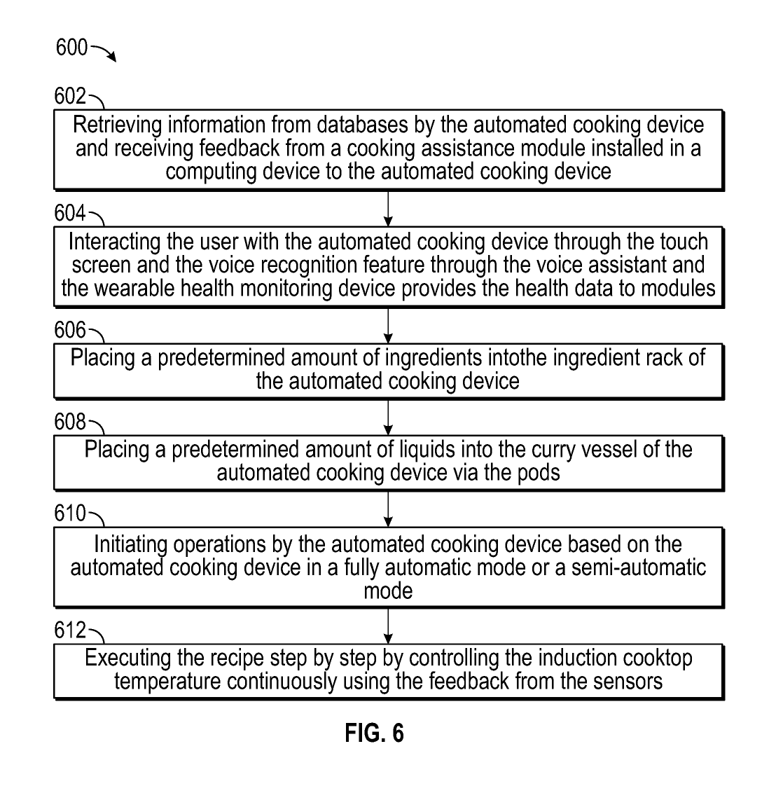

Referring to FIG. 6, FIG. 6 is a flow chart 600 depicting a method for initiating operations of the automated cooking device, according to an exemplary embodiment of the present disclosure. As an option, the method 600 is carried out in the context of the details of FIG. 1, FIG. 2 FIG. 3A, FIG. 3B, FIG. 3C, FIG. 3D, FIG. 3E, FIG. 3F, FIG. 4, and FIG. 5. However, the method 600 is carried out in any desired environment. Further, the aforementioned definitions are equally applied to the description below.

The method commences at step 602, retrieve information from databases by the automated cooking device and receive feedback from a cooking assistance module installed in the computing device to the automated cooking device. Thereafter, at step 604, interact the user with the automated cooking device through the touch screen and the voice recognition feature through the voice assistant and the wearable health monitoring device provides the health data to modules. Thereafter, at step 606, a predetermined amount of ingredients is placed into the ingredient rack of the automated cooking device. The automated cooking device comprises the ingredient steamer which is positioned below the ingredient rack which steams the ingredients before sautéing thereby reducing the cooking time and pushing the ingredients into the curry vessel. Thereafter, at step 608, a predetermined amount of liquids is placed into the curry vessel of the automated cooking device via the pods. Thereafter, at step 610, the automated cooking device initiates operations based on the automated cooking device in a fully automatic mode or a semi-automatic mode. Thereafter, at step 612, the automated cooking device executes the recipe step by step by controlling the induction cooktop temperature continuously using the feedback from the sensors.

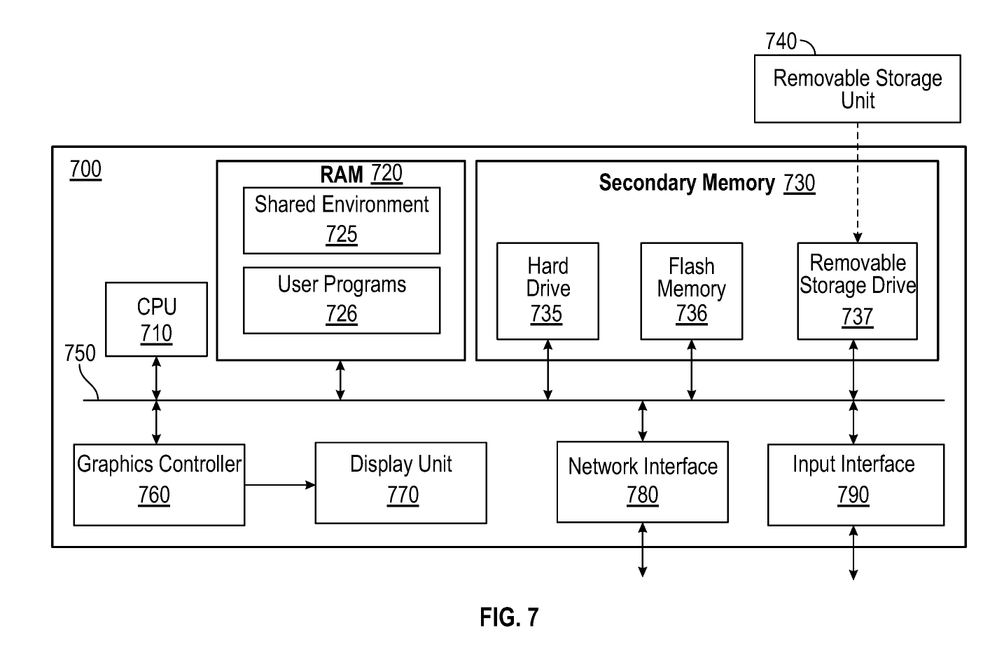

Referring to FIG. 7, FIG. 7 is a block diagram 700 illustrating the details of processing system in which various aspects of the present disclosure are operative by execution of appropriate software instructions. Digital processing system 700 may correspond to the architecture 100 (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems connected to the network.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. An artificial intelligence driven cooking system, comprising:
an intelligence layer is connected to a plurality of databases, whereby said plurality of databases configured to store various information and said intelligence layer configured to collect and analyze the technical data obtained from a plurality of modules;
a device layer comprises an automated cooking device and a cooking assistance module, whereby said cooking assistance module and said automated cooking device are configured to retrieve information from said plurality of databases and a feedback received from said cooking assistance module is used to update the cooking process; and
a computing device comprises a voice assistant and a wearable health monitoring device are connected to said automated cooking device through said cooking assistance module, a user's interaction with said automated cooking device through a touch screen, and the voice recognition feature through said voice assistant and said wearable health monitoring device configured to provide the health data to said plurality of modules, whereby said automated cooking device comprises a curry vessel and an ingredient rack, said ingredient rack configured to hold ingredients that go into said curry vessel and said ingredient rack rotates based on a recipe to dispense said ingredients into said curry vessel at a predetermined interval of time; a rice vessel positioned on a first induction cooktop and said curry vessel positioned on a second induction cooktop, whereby said first induction cooktop configured for cooking rice and said second induction cooktop configured for curry making.

2. The artificial intelligence driven cooking system of claim 1, wherein said automated cooking device comprises stirrers positioned in said curry vessel.

3. The artificial intelligence driven cooking system of claim 1, wherein said automated cooking device comprises a pair of removable pods configured to hold liquids and a motor assembly dispenses said liquids into said curry vessel.

4. The artificial intelligence driven cooking system of claim 1, wherein said automated cooking device comprises a condiment transportation tube configured to transfer condiments from a condiments rack to said rice vessel and said curry vessel.

5. The artificial intelligence driven cooking system of claim 1, wherein said automated cooking device comprises a mechanical arm which acts as a base to said ingredient rack and also rotates said stirrer.

6. The artificial intelligence driven cooking system of claim 1, wherein said automated cooking device comprises a weighing scale configured to weigh said ingredients before placed in said ingredient rack.

7. The artificial intelligence driven cooking system of claim 1, wherein said automated cooking device comprises a touchscreen display configured to display various modes for said user to operate as per the requirement.

8. The artificial intelligence driven cooking system of claim 1, wherein said automated cooking device comprises an infrared thermal camera and a high definition camera are located in said mechanical arm.

9. The artificial intelligence driven cooking system of claim 1, wherein said automated cooking device comprises a steamer in the bottom section of said ingredient rack and said steamer steams vegetables that go into the curry inside said curry vessel on said second induction cooktop.

10. A method for cooking food using an artificial intelligence, comprising:
retrieving information from a plurality of databases by an automated cooking device and receiving feedback from a cooking assistance module installed in a computing device to said automated cooking device, whereby said computing device comprises a voice assistant and a wearable health monitoring device connected to said automated cooking device over a network, said cooking assistance module provides real-time feed of the cooking process and a user enables to modify a recipe using said cooking assistance module;
interacting the user with said automated cooking device through a touch screen and the voice recognition feature through said voice assistant and said wearable health monitoring device configured to provide the health data to a plurality of modules, whereby said automated cooking device comprises a curry vessel and an ingredient rack, said ingredient rack rotates based on a recipe to dispense ingredients into said curry vessel at a predetermined interval of time, a rice vessel positioned on a first induction cooktop and said curry vessel positioned on a second induction cooktop, whereby said first induction cooktop for cooking rice and said second induction cooktop for curry making;
placing a predetermined amount of ingredients into said ingredient rack of said automated cooking device, whereby said automated cooking device comprises an ingredient steamer which is positioned below said ingredient rack which steams said ingredients before sautéing thereby reducing the cooking time and pushing said ingredients into said curry vessel;
placing a predetermined amount of liquids into said curry vessel of said automated cooking device via pods; and
initiating operations by said automated cooking device based on whether said automated cooking device in a fully automatic mode and a semi-automatic mode, whereby said automated cooking device executes said recipe step by step by controlling said induction cooktop temperature continuously using the feedback from sensors.

11. The method of claim 10, wherein said automated cooking device comprises a spice rack with a plurality of pods and dispensing mechanism with a channel which dispenses accurate amounts of spice combinations into said curry vessel.

12. The method of claim 10, wherein said user enables to select said recipe on said automated cooking device's screen or said computing device.

13. The method of claim 10, wherein said automated cooking device runs a status cycle to check the levels of liquids, ingredients, and condiments.

14. The method of claim 10, wherein said sensors comprises: temperature sensors for real time accurate control of temperature of said induction cooktops; humidity sensors sense the requisite humidity for cooking, an acoustic sensor is for sensing whether the food is done as per the requirement, and a pressure sensor detects the pressure maintained in said steamer which steams said ingredients.

15. A computer program product comprising a non-transitory computer-readable medium having a computer-readable program code embodied therein to be executed by one or more processors, the program code including instructions to:
retrieve information from a plurality of databases by an automated cooking device and receiving feedback from a cooking assistance module installed in a computing device to said automated cooking device, whereby said computing device comprises a voice assistant and a wearable health monitoring device connected to said automated cooking device over a network, said cooking assistance module provides real-time feed of the cooking process and a user enables to modify a recipe using said cooking assistance module;
interact a user with said automated cooking device through a touch screen and the voice recognition feature through said voice assistant and said wearable health monitoring device configured to provide the health data to a plurality of modules, whereby said automated cooking device comprises a curry vessel and an ingredient rack, said ingredient rack rotates based on a recipe to dispense ingredients into said curry vessel at a predetermined interval of time, a rice vessel positioned on a first induction cooktop and said curry vessel positioned on a second induction cooktop, whereby said first induction cooktop for cooking rice and said second induction cooktop for curry making;
place a predetermined amount of ingredients into said ingredient rack of said automated cooking device, whereby said automated cooking device comprises an ingredient steamer which is positioned below said ingredient rack which steams said ingredients before sautéing thereby reducing the cooking time and pushing said ingredients into said curry vessel;
place a predetermined amount of liquids into said curry vessel of said automated cooking device via pods; and
initiate operations by said automated cooking device based on whether said automated cooking device in a fully automatic mode and a semi-automatic mode, whereby said automated cooking device executes said recipe step by step by controlling said induction cooktop temperature continuously using the feedback from sensors.

16. The computer program product of claim 15, wherein said plurality of modules comprises a recipe machine learning module utilizes inputs of the data from multiple sources in conjunction to obtain an overview and idea about the doneness of food.

17. The computer program product of claim 15, wherein said plurality of modules comprises a health data machine learning module collects and analyses a health data obtained from said wearable health monitoring device.

18. The computer program product of claim 15, wherein said plurality of modules comprises an image processing module collaborates with said sensors to obtain doneness of food and said image processing module comprises of an Infra-red (IR) thermal camera and a high definition (HD) camera.

19. The computer program product of claim 15, wherein said plurality of modules comprises a NLP module recognizes the speech in the form of user's commands.

20. The computer program product of claim 15, wherein said plurality of databases stores various information such as recipes, user's login information, user's taste profile information, cuisine type, number of persons to be served, information from said sensors, improvisations suggested for every recipe, and technical data for preparation of said recipe.
